(19) United States
(12) Patent Application Publication
(10) Pub. No.: US 2012/0118683 A1
(43) Pub. Date: May 17, 2012

(54) HYBRID BRAKING SYSTEM FOR AUTOMOBILE WITH IMPROVED BRAKING DISTRIBUTION

(75) Inventors: Matthieu Desbois-Renaudin, Villard de Lans (FR); Daniel Chatroux, Teche (FR)

(73) Assignee: Commissariat a l'energie atomique et aux ene alt, Paris (FR)

(21) Appl. No.: 13/387,202

(22) PCT Filed: Jul. 27, 2010
(86) PCT No.: PCT/EP2010/060868

§ 371 Date: Jan. 26, 2012

(30) Foreign Application Priority Data
Jul. 27, 2009 (FR) 0955243

(51) Int. Cl. B60T 13/58; B60T 13/74; B60T 7/04

(52) U.S. Cl. 188/158; 303/3

(57) ABSTRACT

A braking system for an automobile including an electromagnetic braking subsystem and an electric or hydraulic subsystem, the electromagnetic braking subsystem including a converter to convert kinetic energy of the vehicle into electrical energy, the converter outputting a generated current, a device storing or dissipating electrical energy regenerated by the electromagnetic braking subsystem, and an electrical actuator to limit the braking power of the electric or hydraulic braking subsystem as a function of the braking power of the electromagnetic braking subsystem, the electrical actuator being electrically controlled by the generated current or by an image signal of the generated current.

### TECHNICAL FIELD AND PRIOR ART

This invention relates to an electric braking system for an automobile that functions more safely and an automobile comprising such a braking system.

Traditionally, automobiles comprise an internal combustion engine to drive the driving wheels and a hydraulic braking system to apply a braking force on the vehicle wheels. The hydraulic braking system comprises a master cylinder actuated by a brake pedal controlled directly by the driver and brakes located at the wheels. The master cylinder is connected to the brakes through a hydraulic circuit full of brake fluid. When the driver presses the brake pedal, the master cylinder pistons slide and increase the pressure in the brake fluid in the circuit, actuating the brakes and causing braking. The braking power depends on the force applied on the pedal. The driver feels a reaction at the pedal that helps him to control the braking power.

Over the last few years, vehicles have developed that use an electric rather than a fossil driving energy, the wheels being driven by an electric motor. It was then thought that the electric motors could be used as converters to convert the kinetic energy of the vehicle into electrical energy and thus brake the vehicle. The electrical energy thus generated is either stored in a battery for use later, for example to generate a driving force, or dissipated in resistances, or used directly by an electric auxiliary in the vehicle (brake, heating, etc.). This type of braking system is called a regenerative braking system. However, the vehicle is always provided with a hydraulic braking system for safety reasons, to make a direct connection between the pedal and the brakes in case the regenerative braking system should fail. Furthermore, regenerative braking is not always necessarily preferable. For example, electromagnetic braking can consume energy at low speed. And once the battery is fully charged, the electromagnetic brake can no longer be used or this energy has to be dissipated which requires resistances and temperature control means.

Thus, the two braking systems can function simultaneously and each provides part of the total braking power. Therefore, the proportion of the braking power provided by each system has to be managed so that the power actually provided corresponds to the braking required by the driver.

Document US 2007/0126382 discloses a braking system comprising a regenerative braking subsystem and a hydraulic braking subsystem. The subsystem comprises a master cylinder actuated by a brake pedal. When the driver presses on the brake pedal, the hydraulic pressure generated is measured and is sent to the computer as the braking set value. The computer uses this set value and sends a command to the regenerative braking subsystem that then generates a braking force on the wheels. The computer sends a command to the hydraulic braking subsystem so that it generates a hydraulic pressure to complete the regenerative braking power, based on the braking power predetermined as a function of the braking set value.

This system requires a large number of sensors and uses the computer to generate orders based on the hydraulic pressure that is converted into a set value. This system is complex in operation and there is a potential for it to fail in several ways.

Document WO 2008/107212 discloses a hybrid braking system comprising a regenerative braking subsystem and a hydraulic braking subsystem, in this case the ABS system that regulates the braking pressure generated by the hydraulic subsystem. The ABS system is controlled as a function of the braking set value provided by the driver.

In hybrid braking systems according to the state of art, the set value signal and the electric signal that is an image of the electromagnetic torque at the brakes are transformed several times. These multiple transformations can be sources of failure and make the braking system inefficient. The braking system is a safety device, and it must be reliable.

Consequently, one of the purposes of this invention is to propose a braking system comprising a regenerative braking subsystem and a hydraulic or electric braking subsystem, in which the distribution of the braking power generated by the two subsystems is managed in a simple and safe manner.

### PRESENTATION OF THE INVENTION

The purpose stated above is achieved by a braking system for an automobile comprising a regenerative braking subsystem and a hydraulic or electric braking subsystem, the regenerative braking subsystem comprising an electric machine capable of converting the kinetic energy of the vehicle into electrical energy during a braking phase, and means of regulating the braking power generated by the hydraulic or electric braking subsystem, said means being controlled by the current generated by the electric machine during electromagnetic braking.

In other words, physical coupling is created between the electromagnetic braking subsystem and the hydraulic or electric braking using the current generated by the electromagnetic braking subsystem, this generated current being directly representative of the proportion of the power generated by the electromagnetic braking. Using the generated current means that there is no need for a computer, avoiding the need to transform the generated current into another magnitude which reduces the risk of failure. This regulation also takes place continuously as long as the electric machine outputs a current.

The current generated may be used either directly to control the braking power regulation means, or an image of this current that is another current or a voltage may be used.

According to the invention, the coupling between the electromagnetic braking and the hydraulic or electric braking of the vehicle is regulated by a physical method that does not require a computer. This regulation has the important advantage of functioning permanently, simply due to physical laws. The coupling system according to the invention assures that the hydraulic or electric braking system is permanently adapted as a function of the electromagnetic braking. It eliminates all possible calculation errors by a microcomputer. The components used (transformer, solenoid) are very reliable components, and there are very few failure modes in the entire system. This invention also gives more freedom with system design.

Advantageously, the regulation means transform the generated current or the image of the generated current into a mechanical force, for example acting on the brake pedal that controls the hydraulic pressure in the hydraulic braking subsystem, or on a piston in the master cylinder, or on a hydraulic pressure limiter.

The subject-matter of this invention is then mainly a braking system for an automobile comprising an electromagnetic braking subsystem and an electric or hydraulic braking subsystem, said electromagnetic braking subsystem comprising a converter to convert the kinetic energy of the vehicle into electrical energy, said converter outputting a so-called generated current, a means of storing or dissipating the electrical energy regenerated by the electromagnetic braking subsystem, characterised in that said braking system also comprises electrical actuation means to limit the braking power of the electric or hydraulic braking subsystem as a function of the braking power of the electromagnetic braking subsystem, said electrical actuation limitation means being electrically controlled by the generated current or by an image signal of the generated current.

In one embodiment, the electric or hydraulic braking subsystem is actuated by a brake pedal on which the driver applies a braking force, said limitation means applying a force on the brake pedal opposing the braking force applied by the driver on the brake pedal.

In another embodiment, the hydraulic braking subsystem comprises a master cylinder, said master cylinder comprising at least one piston, said limitation means applying an opposing force on said piston in the direction opposite to the displacement of the piston in a direction in which the pressure increases inside the master cylinder.

The master cylinder may for example be a tandem master cylinder and the opposing force is applied on the secondary piston. Advantageously, the hydraulic braking subsystem comprises a circuit in parallel.

Said limitation means may comprise an actuator formed by a solenoid powered by the generated current or an image of said generated current, and a mobile element in the solenoid, said mobile element being capable of applying an opposing force, or of the piezoelectric type, or of electric motor type coupled to a helical transmission.

In another embodiment, the hydraulic braking subsystem comprises a hydraulic pressure source, the limitation means comprising a pressure limiter device inserted between the hydraulic pressure source and the brakes and capable of interrupting the fluid communication between said pressure source and the brakes, the cut off pressure of the limiter device being fixed by an actuator controlled by the generated current or by an image of the generated current.

The pressure limiter device comprises for example a body inside which a piston delimiting two chambers slides in a leak tight manner, one of the chambers being connected to said pressure source and the other chamber being connected to the brakes, the piston comprising a passage in the piston and a valve, opening of the valve being controlled by the position of the piston, the position of the piston being controlled by the pressure difference between said two chambers, closing of the valve causing the pressure limitation in the brakes, the position of the piston being controlled by the actuator. The actuator may be a solenoid powered by the generated current or an image of said generated current, and a mobile element in the solenoid, the position of the mobile element defining the cut off pressure, or it may be a piezoelectric type, or of the electric motor type coupled to a helical transmission.

For example, the pressure limitation means are connected directly to the terminals of the electric machine.

Advantageously, the braking system according to the invention comprises a toroidal current transformer or an LEM sensor at the output from the electric machine, to which the pressure limitation means are connected.

In the case in which the electric braking subsystem comprises at least one electric braking device at a wheel to actuate the brakes and in which said limitation means may either apply a force opposing the force applied by the electric braking device or may comprise a coil in which the generated current or an image of the generated current circulates, creating a magnetic field opposing the field created by the braking device, or it may comprise an electric circuit capable of subtracting the generated current or the image of said generated current from the control current of said electric braking device.

The braking system for an automobile according to this invention advantageously comprises a switch in the limitation means power supply circuit, said switch being open when the driver does not give an order to brake and is closed when the driver gives the order to brake.

### BRIEF DESCRIPTION OF THE DRAWINGS

This invention will be better understood after reading the following description and the appended drawings in which:

FIGS. 1A to 1C are schematic views of a first embodiment of a braking system according to this invention, the regulation being done at the brake pedal,

FIG. 1D is a variant embodiment of the system in FIG. 1B,

FIG. 2 is a diagrammatic view of a second embodiment of a braking system according to this invention, the regulation being done at the master cylinder,

FIG. 3 is a diagrammatic view of a detail of a third embodiment of a braking system according to this invention, the regulation being obtained by a pressure limiter,

FIG. 4 is a diagrammatic view of a variant of the first embodiment of the braking system according to the invention.

### DETAILED PRESENTATION OF PARTICULAR EMBODIMENTS

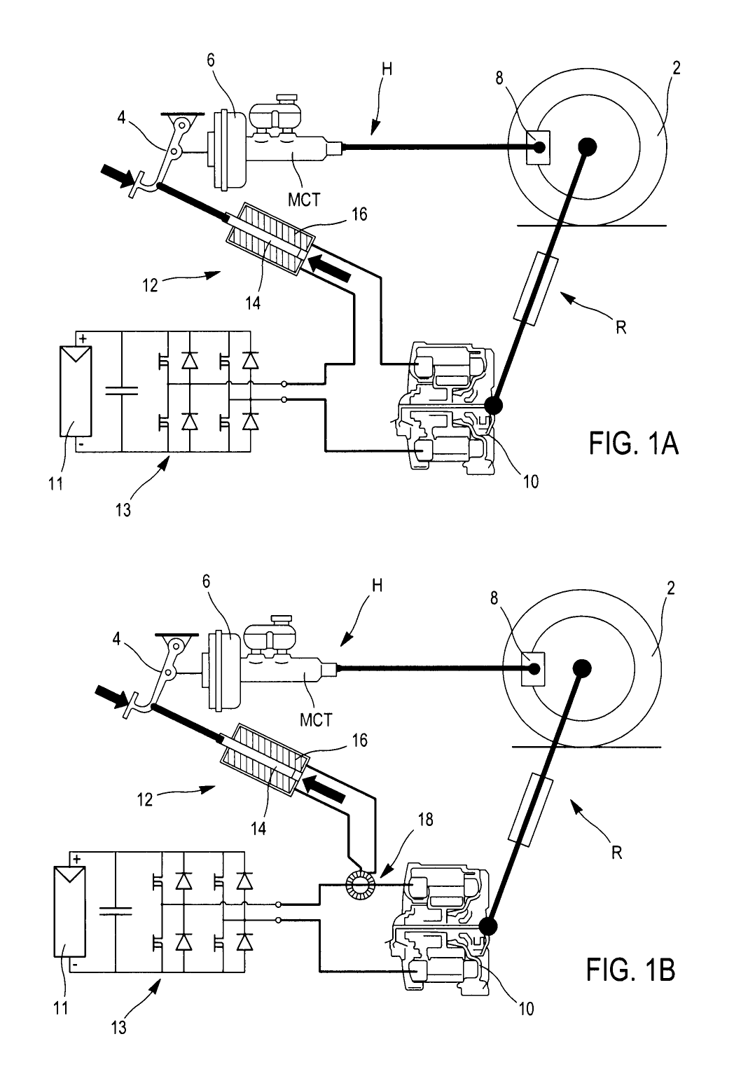

FIG. 1A shows a first braking system for an automobile according to this invention.

In FIG. 1A, only one wheel 2 of the automobile is shown, although it should be clearly understood that the braking system according to this invention can be applied to more than one wheel, advantageously to two or four wheels on the automobile.

The braking system according to this invention comprises a control device, in the example shown formed by a brake pedal 4 moved by the driver and that translates the degree of braking required by the driver, a regenerative or electromagnetic braking subsystem R and a hydraulic braking subsystem H, the subsystems being actuated by the brake pedal 4.

In the example shown, the hydraulic braking subsystem H comprises a tandem master cylinder MCT actuated by the brake pedal 4 through a control rod and a power assistance servomotor to the brake 6, the tandem master cylinder MCT being hydraulically connected to the brakes 8 at the wheels 2. For example, the brakes may be disk brakes.

The electromagnetic braking subsystem R comprises an electric machine 10 capable of converting the kinetic energy from the wheel 2, more particularly from the brake disk which is itself fixed to it in rotation, into electrical energy. This electrical energy is advantageously stored in a battery. It could also be dissipated through resistances or it could be used directly by an electric auxiliary.

Advantageously, during a driving phase, the electric machine 10 forms a motor and drives one or more driving wheels instead of an internal combustion engine. An electric machine 10 may be provided at each wheel.

When electromagnetic braking takes place, the electric machine 10 generates an electric current, the value of which is related to the value of the braking torque applied by the electromagnetic force, this current exits from the coil of the electric machine towards a battery 11 as shown diagrammatically, and/or a super capacitance and/or one or more dissipation resistances. The charging circuit 13 of the battery 11 is also shown diagrammatically.

The electric machine 10 acts as an electricity power source when braking is applied, in which the voltage depends on the rotation speed (counter electro-motive force) and the current is related to the braking torque. The electric current that exits from the electric machine 10 during an electromagnetic braking phase will be called the “generated current”.

In the first embodiment of this invention, the braking system comprises means 12 of limiting the hydraulic pressure that will apply an opposing force on the brake pedal 2. These means 12 apply a reaction that is additional to the reaction generated by the hydraulic braking circuit itself.

These limitation means 12 may be formed by an electromagnetic actuator. In the example shown, the means 12 comprise a solenoid 16 in which a mobile element 14 is placed that can be displaced when a current circulates in the solenoid 16. The mobile element 14 is fixed to the movement of the brake pedal 2 and it can apply an opposing force to the pedal opposing the force applied by the driver's foot. The solenoid 16 is directly connected in series to the electric machine 10 and the battery 11, therefore the generated current passes through it directly.

The force supplied by the solenoid 16 is based on the principle of variable reluctance; when a field appears inside the solenoid, the mobile element located inside tends to move to minimise the resistance to the created magnetic field (reluctance). For a given position of the mobile element, the resultant force is proportional to the magnetic field created and therefore to the current passing through the solenoid. Since the current passing through the solenoid is directly the image of the current output from the electric machine and therefore the electromagnetic braking torque, the force applied by the mobile element on the pedal depends on the braking power of the electromagnetic braking subsystem.

The force applied by the mobile element opposes the driver's force on the brake pedal 2, which consequently limits the pressure of the brake fluid in the hydraulic brakes, this limitation depending on the braking power of the electromagnetic braking subsystem.

Consequently, a distribution of the braking power between the electromagnetic subsystem and the hydraulic subsystem is obtained in a simple manner with a minimum number of additional components, based directly on the braking power output by the electromagnetic subsystem. This example embodiment has the advantage that it limits the number of transformations of the signal formed by the generated current. The solenoid transforms it into a magnetic field, and it is then transformed into a reaction force on the brake pedal. Therefore, the risks of failure are reduced.

FIG. 1B shows another example embodiment comprising a generated current transformer 18 in series with the electric machine 10, the solenoid 16 being powered by the current output from the transformer 18. A toroidal current transformer as shown is preferred for an AC electric machine, while a Hall effect sensor will be preferred for a DC electric machine.

The current output from the toroidal current transformer 18 is a physical signal proportional to the generated current output from the electric machine 10. This example embodiment has the advantage that it facilitates transport of the signal as far as the limitation means 12 close to the brake pedal. The image signal output from the transformer, i.e. a low intensity current, may be carried by smaller wires than are necessary for the generated current.

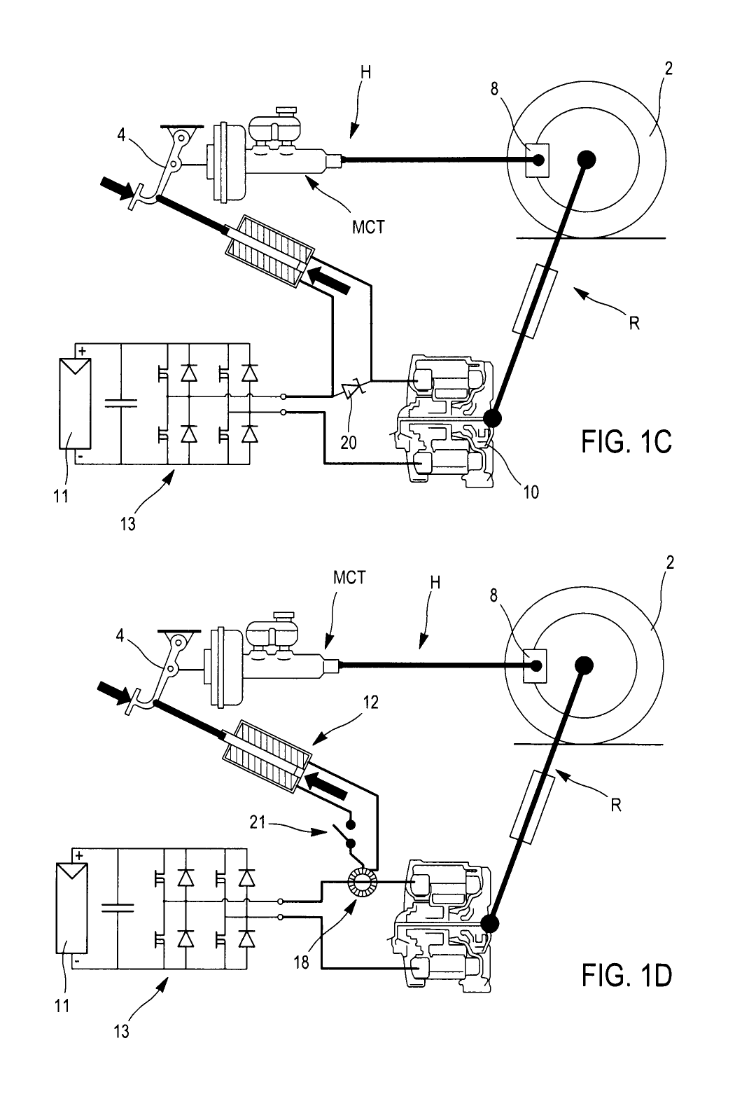

As shown in FIG. 2C, it would also be possible to mount a Zener diode 20 in series with the electric machine, the limitation means 12 being connected to the terminals of the Zener diode 20.

It is understood that the hydraulic pressure limitation means 12 may be different from those described. Any electric actuator capable of applying an opposing force on the brake pedal, and more generally on any element of the hydraulic braking system to limit the hydraulic pressure in the brakes, can be used. For example, it could be a voltage controlled piezoelectric actuator. This type of actuator is particularly suitable in the case of the system in FIG. 2C or in the case of a DC machine with a Hall effect sensor.

The actuator may also be formed by an electric motor associated with a gear and worm screw type helical transmission, the worm screw being mechanically coupled to the brake pedal 2 or to a rack transmission, or to any other transmission capable of transforming a rotation movement into an opposing force on the pedal.

FIG. 1D shows a variant embodiment of the system in FIG. 1B, in which the coupling is made inactive when an acceleration order is given.

According to this invention, coupling is permanently active, regardless of whether the electric machine applies a braking torque or a traction torque. In the latter case, coupling plays no role. The limitation of the braking force is not a problem in the case of traction because there is never any need to accelerate and brake at the same time in normal operating mode. The master cylinder does not send any pressurised brake fluid into the brakes.

Nevertheless, an operational mode could be envisaged (for example if the driver makes a mistake) in which the electric machine outputs a traction torque at the same time as the vehicle driver requests high power braking, in this case braking would be limited.

This case is solved by using a switch 21 in the solenoid power supply circuit, more generally the reaction actuator circuit, which is open when the brake pedal is not pressed and which closes when the brake pedal is pressed. For example, this switch is coupled to the brake lights contactor.

It is understood that a braking system controlled for example by means of a lever moved by hand is not outside the scope of this invention. In this case, the limitation means 12 are applicable.

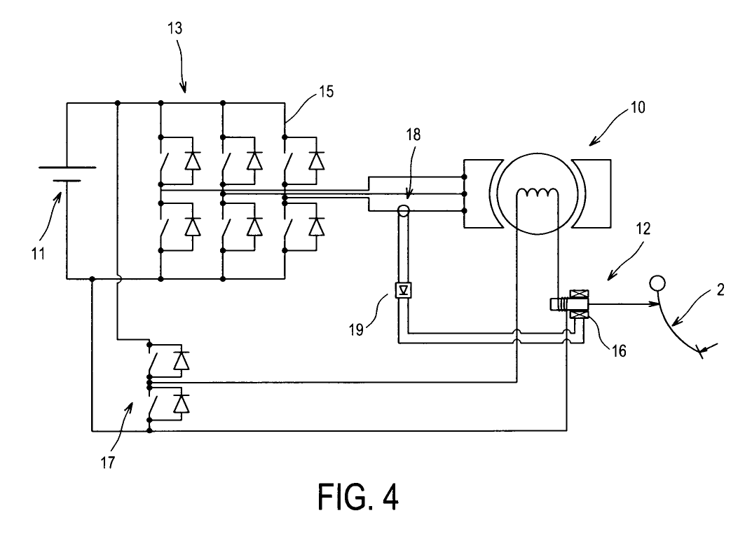

One possible embodiment variant is as follows, applicable in the case in which the electric machine is a synchronous motor with wound rotor. This variant is shown diagrammatically in FIG. 4. In this case, the braking torque output by the motor is proportional to the product of the induced and excitation currents according to the following equation:

Cₘₒₜ=Kₘₒₜ·Φ·i_{induced}=Kₘₒₜ·L_{excitation}·i_{excitation}·i_{induced}=K′·i_{excitation}·i_{induced}

The resultant force of the solenoid is proportional to the power supply current of the solenoid and the flux generated by the winding around its core. This flux itself is proportional to the current passing through the winding, giving:

Fₛₒₗ=Kₛₒₗ·i_{excitation}·i_{induced}

These two equations are used to determine a proportionality relation between the driving torque and the force applied by the solenoid. Thus, physical coupling is obtained between hydraulic braking and electromagnetic braking such that the hydraulic braking torque is reduced by the electromagnetic braking torque.

In the example shown in FIG. 4, the winding of the solenoid core is directly powered by the motor excitation current. An LEM type of electromagnetic current sensor can be used with an analogue amplifier to recover an image of this current and to limit consumption on the excitation circuit.

In this variant, the solenoid 16 is powered by the current output from the transformer 18 through a rectifier 19. The charging circuit 13 of the battery 13 comprises a three-phase converter 15. An excitation clipper 17 is provided at the battery terminals to supply power to the electric machine.

FIG. 2 shows another embodiment of a braking system according to this invention, in which means of limiting the hydraulic pressure 112 are included acting directly on one of the pistons of the tandem master cylinder.

In the example shown, the tandem master cylinder MCT is divided into two primary and secondary working chambers 22, 24 delimited by the primary piston 26 and the secondary piston 28.

The primary piston is moved directly by the brake pedal or through a power assistance device and the secondary piston is displaced by displacement of the primary piston, more precisely by the pressure generated in the primary chamber 22 and the spring placed between the two pistons.

Each working chamber 22, 24 is hydraulically connected to two brakes. In the case of a circuit in parallel, one chamber supplies the two front wheels and the other chamber supplies the two rear wheels. In the case of an X circuit, one chamber supplies the front left wheel and the rear right wheel and the other chamber supplies the front right wheel and the rear left wheel.

In the example shown, the hydraulic reaction limitation means, for example the solenoid, acts on the secondary piston 28 and applies an opposing force on the secondary piston tending to limit the pressure in the secondary chamber and therefore in the brakes that it supplies.

The limitation means 12 are controlled as in the embodiment in FIGS. 1A to 1D, either directly by the generated current or by the image of the generated current, for example obtained by a transformer as described.

This embodiment has the advantage of distributing braking power on only two wheels instead of on the four wheels, as is the case when the brake pedal is used.

We will use this second embodiment of the invention and an example of a parallel assembly, to show that the braking pressure can be modulated for the wheels on the axle connected to the secondary hydraulic circuit independently of the pressure in the primary circuit. This is done by assuming that the primary circuit is connected to the rear axle and the secondary circuit is connected to the front wheel brakes. Only the front wheels are fitted with electromagnetic brakes, and the rear axle is only provided with hydraulic brakes.

In general, the hydraulic braking torque C_{FH} on the brake disk can be written as follows:

C_{FH}=r·F

F=f·P_{H}·S

C_{FH}=α·P_{H} (I)

Where:

r distance at which the brake pad applies the force F on the brake disk;

P_{H} the pressure applied by the hydraulic system;

S the surface area on which the pressure P_{H} is applied to force the brake pad into contact with the disk;

f the coefficient of friction of the contact between the disk and the brake pad;

F the force with which the pad is forced onto the disk.

The force F is directly proportional to the coefficient of friction and to the force applied by the piston.

Therefore the hydraulic braking torque applied by the primary circuit is written as follows, based on relation (I),

C_{FH}_{_{—P}}=r·f·P_{P}·S

In general, the balance of forces applied to the primary piston is

P_{P}·S_{Piston}+k·Δx_{P}=F_{Rod} (II)

Where:

k is the stiffness of the return spring in the primary chamber;

Sₚᵢₛₜₒₙ the working cross-section of the primary piston;

Δx_{P} the compression of the spring associated with the primary piston, and

F_{Rod} the force applied by the operator through the brake pedal.

If a force is applied on the secondary piston opposing its displacement in the sense of an increase in the pressure in the secondary chamber 24, the balance of forces applied to the primary piston 26 remains unchanged. It can be deduced that the pressure on the primary piston is:

$${P}_{P} = \frac{{F}_{Rod} - k \cdot Δ {x}_{P}}{{S}_{Piston}}$$

Therefore the braking force on the rear axle remains unchanged.

Therefore, by acting on the secondary piston, it is possible to modulate the pressure only in the brakes supplied by the secondary circuit.

We will now determine the hydraulic braking force generated by the secondary circuit.

Using relation I, we can write that the hydraulic braking torque of the secondary circuit C_{FH}_{_{S}} is:

C_{FH}_{_{S}}=r·f·P_{S}·S

The balance of forces (relation II) applied to piston 28 is modified as follows, where Fₛₒₗ is the force applied by the solenoid:

$${P}_{S} \cdot {S}_{Piston} + k \cdot Δ {x}_{s} + {F}_{sol} = {F}_{Rod}$$

$${P}_{S} = \frac{{F}_{Rod} - k \cdot Δ {x}_{P}}{{S}_{Piston}} - \frac{{F}_{sol}}{{S}_{Piston}}$$

Let C_{standard} be the braking torque due to the hydraulic system that would have been obtained without coupling, and the following expression is then obtained for the braking torque for the front axle:

$${C}_{FH\_S} = {C}_{Standard} - \frac{{F}_{sol}}{{S}_{Piston}} \qquad ( III )$$

As explained above, the current passing through the solenoid is directly related to the image of the current output from the electric machine and therefore the electromagnetic braking torque C_{EM}, Fₛₒₗ is proportional to I_{generated}, so that we can write:

C_{FH}_{_{S}}=C_{Standard}−K·C_{EM} (IV)

K is then the global proportionality gain. This gain depends on the design of the solenoid (number of turns, piston geometry, presence of a magnet in the piston) and the mode chosen for coupling between the generated current and the solenoid current (i.e. transformation ratio of the toroidal current transformer). Components can be chosen to obtain a value of K=1 so that the hydraulic braking force on the front axle permanently reduces the electromagnetic braking force on the same axle.

The electromagnetic braking force on the front axle is written as follows:

C_{EM}=β·I_{induced}

Finally, the total force on the front axle is:

C_{BRAKE}=C_{FHS}+C_{EM}=C_{Standard}−K·C_{EM}+C_{EM}

For an adapted value of K=1, we obtain:

C_{BRAKE}=C_{Standard}

Consequently, the total braking torque then remains constant as optimised for the hydraulic braking system, regardless of the operating conditions of the hydraulic braking system and the electromagnetic braking system.

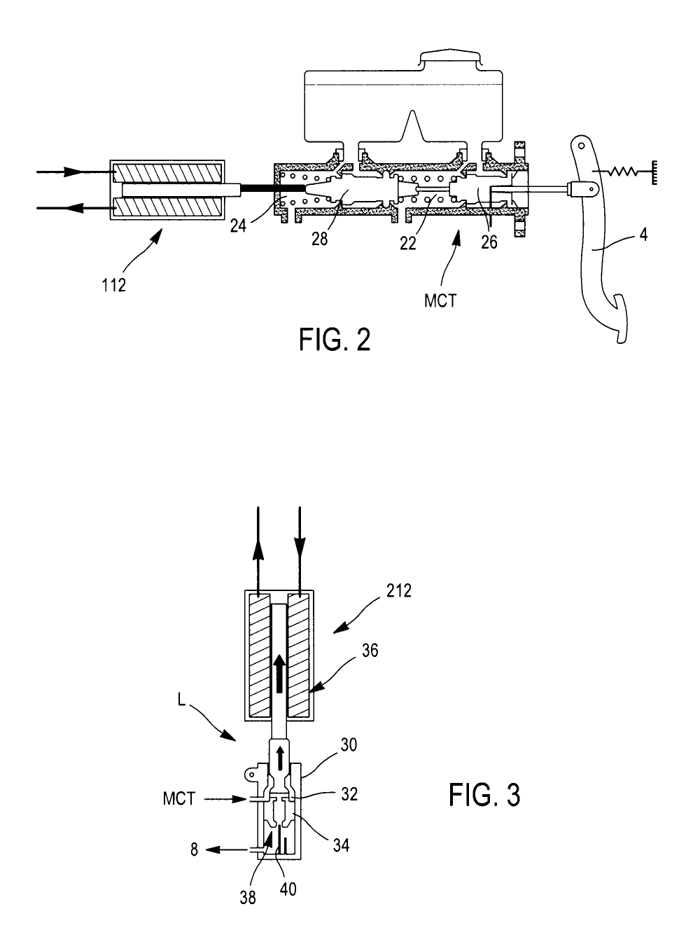

FIG. 3 shows another embodiment in which this invention acts between the master cylinder and the brakes to limit the hydraulic pressure output to the brakes. The master cylinder can then be replaced by another pressure source like a hydraulic pump.

FIG. 3 shows another embodiment of the means 212 to limit the hydraulic pressure in the brakes as a function of the electromagnetic braking power. The means 212 comprise a body 30 in which a chamber 32 is connected firstly to one of the master cylinder chambers and secondly to the brakes. A piston 34 is installed free to slide leak tight in the chamber 32. The piston 34 comprises a passage 36 that can be closed by a valve 38. For example, the valve 38 is a ball valve, the ball being forced into contact with the valve seat made in the piston by a return spring. An opening rod 40 is also provided to keep the ball separated from the valve seat when the piston 34 is in a low position beyond a given level.

The piston 34 comprises two faces on which the pressure in the master cylinder is applied. The brakes can be applied when the valve 38 is open, i.e. when the piston 34 is in a sufficiently low position.

Furthermore, according to the invention, an actuator 36 is provided to modify the rest position of the piston 34 relative to the opening rod 40.

For example, the actuator is formed by a solenoid in which a mobile element can slide, similar to that described in relation to FIGS. 1A to 1D. According to the invention, this solenoid is powered by the generated current in a manner similar to the system in FIG. 1A or by an image of the generated current, in a manner similar to the systems in FIGS. 1B and 1C.

The mobile element that slides in the solenoid is fixed to the piston 34 sliding in the body. As the value of the generated current or its image circulating in the solenoid increases, the position of the piston 34 becomes higher and the pressure in the master cylinder necessary to open the valve to enable an additional increase in the pressure of the brake fluid in the brake(s) increases.

The equilibrium of the piston 34 is governed by the following equation in a known manner:

$$P 2 = \frac{F 2}{S 2} = \frac{S 1}{S 2} \cdot P 1 \qquad ( V )$$

Where:

F2 is the force applied by the solenoid;

P1 is the pressure in the master cylinder;

P2 is the pressure in the brake;

S1 is the cross-sectional area on which P1 is applied;

S2 is the cross-sectional area on which P2 is applied;

S12 is the part of the cross-sectional area S2 on which the pressure P1 is not applied.

If the design used is such that the surface areas S1 and S2 are equal, the following new relation is obtained:

$$P 2 = P 1 + \frac{F 2}{S 2}$$

As already explained, in the device in FIG. 3 the force applied by the solenoid tends to lift the piston 34 and is therefore opposite to the force F2 as defined in equation V. If this new force is denoted Fₛₒₗ, the result obtained is:

$$P 2 = P 1 - \frac{{F}_{sol}}{S 2}$$

With this new system, P2 is equal to P1 as long as the force Fₛₒₗ is zero. If this force becomes non-zero, then the braking pressure is reduced proportionally to this force. Consequently, for a hydraulic braking system in parallel, the total braking torque on the front axle is conserved by determining transformation elements such that the ratio K of relation IV is equal to 1.

We will now explain operation of the braking system fitted with the braking power limitation device according to this invention.

When the driver wants to brake, he presses on the brake pedal, his order is detected, a central unit sends an order to the regenerative braking system that controls the electric machine such that it creates a braking force. The braking force is converted into a current through the electric machine that outputs the generated current. Simultaneously, the master cylinder sends pressurised brake fluid to the brakes.

The generated current or its image circulates in the solenoid causing an upwards displacement of the piston 34, the valve 38 is closed, the ball pressing on the valve seat. Consequently, the communication between the master cylinder MCT and the brakes is interrupted and the increase in pressure in the brakes is limited. This limit is imposed by the position of the piston 34 that is directly dependent on the value of the generated current or its image, which is representative of the braking power output by the regenerative braking system. Therefore, there is a distribution of the braking power between the regenerative braking system and the hydraulic braking system based on the braking power of the regenerative braking system.

If the force applied on the brake pedal increases, the pressure in the master cylinder increases, and acts on the piston 34. At the same time the electromagnetic braking increases, which increases the generated current causing a displacement of the piston 34 in the opposite direction. A new state is reached in which the proportion of the braking power output by the hydraulic braking system to the brakes has been adapted.

The limitation means 212 according to this invention may advantageously be used in a circuit in parallel, a single limiter device being inserted between the master cylinder and the brakes on the same axle.

Such means may also be provided for each brake.

The limitation means 212 are particularly advantageous because they can reduce the size and therefore the cost of components. Direct action of the solenoid on the master cylinder may require high forces and therefore components sized accordingly.

The hydraulic braking system as described up to now comprises a tandem master cylinder, but It is understood that a braking system comprising a master cylinder with a single chamber supplying the four brakes will not be outside the scope of this invention.

There are also braking systems in which the master cylinder acts as a pedal sensation simulator, the increase in pressure in the brakes being obtained by means of hydraulic pumps. The hydraulic pumps are controlled based on a measurement of the braking level required by the driver, particularly by measuring the travel distance of pistons. This invention is also applicable in this case and the limitation means are applied on the pistons simulating the pedal sensation. The reaction thus applied to the simulation pistons will modify the set value sent to the hydraulic pumps as a function of the electromagnetic braking power.

It is understood that, the wheel anti-blocking system may be managed by the electromagnetic braking system. It would also be possible to envisage deactivating the electromagnetic braking system when a risk of blockage of the wheels is detected, and to manage this situation entirely through the hydraulic braking system.

The hydraulic braking system may also be replaced by an electric braking system, i.e. for example the brake pads being applied onto the disk or the linings being applied onto the drums by an electric braking device comprising an electric motor actuating a gear and worm screw system.

In the case in which an electric braking system is used, it would be possible to supply a solenoid type electric actuator using the generated current or the image of the generated current that applies a force opposing the electric braking device. It would also be possible for the image current of the generated current to pass through a coil that generates a magnetic field opposite to the magnetic field created by the electric braking device. It would also be possible to make an electric circuit capable of subtracting the current supplying the electric actuator from the image current of the generated current.

The braking circuit in parallel is particularly advantageous for the braking system according to this invention, particularly in the case in which action is applied on the secondary piston of the tandem master cylinder. In the framework of this invention, such a braking system provides sufficient safety, even if the primary or secondary circuit should fail. In the case of a failure in the hydraulic braking system on the front axle, the entire hydraulic braking power of the rear circuit is available together with the electromagnetic braking power. The electromagnetic braking power for an electric vehicle is usually equal to the maximum traction power.

We will now describe the design of a braking system according to this invention, for example purposes only.

We will consider a braking system with the following characteristics:

amplification at the pedal: k1=4;

amplification at the hydraulic system: It is understood that k2=10;

coefficient of friction of brake linings: It is understood that f=0.4;

average radius of disks: r=190 mm.

We will assume that a braking force applied by the driver on the pedal corresponds to F_{cde}=100 N. We will then obtain a clamping force of the brake pads on the disks equal to:

R_{D}=k₁·k₂·F_{cde}=4000N

Since there are four brake pads that act on the two disks on the front axle, we obtain a braking torque on the front axle equal to:

C_{brake}=4·R_{D}·f·r=1216 Nm

We will now consider the system according to the first embodiment of this invention shown in FIG. 1, with a solenoid powered directly by the generated current.

The vehicle is equipped with an electric machine with the following characteristics:

DC machine;

nominal power: 22 kW;

nominal current 54 A corresponding to a nominal torque of 60 Nm;

reduction ratio between electric machine and wheels: Kred=4.

Since the braking force is greater than its maximum torque, the electric machine operates at its nominal torque of 60 Nm so as to regenerate the maximum amount of energy. The equivalent braking torque on the front axle is then 240 Nm for a current of 54 A. We will verify that the hydraulic braking torque has been correspondingly reduced. This operation is done by applying a force on the control piston of the primary circuit in the direction opposite to the force applied by the control rod. This force is:

$${F}_{Sol} = \frac{240}{4 \cdot f \cdot r} \cdot \frac{1}{{k}_{2}} = 79 N$$

The solenoid must be capable of outputting a force of 79 N when the current generated by the electric machine is 54 A. The Magnet-Schulz company markets a solenoid reference “G RF Y 035 F20 B02” that outputs 58N for a current of 0.68 A. If two solenoids of this type are used in series, 0.93 A is necessary to obtain 79N. Considering that the induced current produced by the electric machine is 54 A and it passes through the solenoid, the number of turns in the solenoid would have to be divided by 58 to obtain the same magnetomotive force in the magnetic circuit.

In the special case of a DC electric machine, it is commonly assumed that the electromagnetic braking torque CEM is expressed as a function of the generated current I and the flux present in the electric machine Φ, according to the following equation:

C_{EM}=k_{MCC}·Φ·I

k_{MCC} is a constant proportionality factor, that depends only on the physical properties of the machine (dimensions, winding, etc.). Therefore, it is observed that the torque is directly proportional to the current for a constant excitation current. The above reasoning is applicable to the entire operating range of the electric machine, provided that the flux remains constant.

It is possible to determine the flux in any electric machine by inserting a measurement coil in the machine or simply using the rotor excitation current (for example for a DC machine). This flux image could be used to excite the “mechanical actuator” part of the solenoid and thus increase the force generated by the assembly.

The invention discloses a hybrid braking system for an automobile capable of simply and reliably regulating the hydraulic or electric braking power as a function of the electromagnetic braking power, while limiting information losses.

1-17. (canceled)

18: A braking system for an automobile comprising:
an electromagnetic braking subsystem comprising a converter to convert kinetic energy of the vehicle into regenerated electrical energy, the converter outputting a generated current;
a device for storing or dissipating the electrical energy regenerated by the electromagnetic braking subsystem;
an electric or hydraulic subsystem;
an electrical actuator to limit braking power of the electric or hydraulic braking subsystem as a function of braking power of the electromagnetic braking subsystem, the electrical actuator being electrically controlled by the generated current or by an image signal of the generated current.

19: A braking system for an automobile according to claim 18, in which the electric or hydraulic braking subsystem is actuated by a brake pedal on which the driver applies a braking force, the electrical actuator applying a force on the brake pedal opposing the braking force applied by the driver on the brake pedal.

20: A braking system for an automobile according to claim 19, in which the hydraulic braking subsystem comprises a master cylinder, the master cylinder comprising at least one piston, the electrical actuator applying an opposing force on the piston in a direction opposite to displacement of the piston in a direction in which pressure increases inside the master cylinder.

21: A braking system for an automobile according to claim 20, in which the master cylinder is a tandem master cylinder and the opposing force is applied on a secondary piston.

22: A braking system for an automobile according to claim 20, in which the hydraulic braking subsystem comprises a circuit in parallel.

23: A braking system for an automobile according to claim 21, in which the hydraulic braking subsystem comprises a circuit in parallel.

24: A braking system for an automobile according to claim 18, in which the electrical actuator comprises an actuator comprising a solenoid powered by the generated current or an image of the generated current, and a mobile element in the solenoid, the mobile element being capable of applying an opposing force.

25: A braking system for an automobile according to claim 24, in which the actuator is a piezoelectric actuator.

26: A braking system for an automobile according to claim 24, in which the actuator is an electric motor coupled to a helical transmission.

27: A braking system for an automobile according to claim 18, in which the hydraulic braking subsystem comprises a hydraulic pressure source, the electrical actuator comprising a pressure limiter device inserted between the hydraulic pressure source and the brakes and capable of interrupting fluid communication between the pressure source and the brakes, a cutoff pressure of the limiter device being fixed by an actuator controlled by the generated current or by an image of the generated current.

28: A braking system for an automobile according to claim 27, in which the pressure limiter device comprises a body in which a piston delimiting two chambers slides in a leak tight manner, one of the chambers being connected to the pressure source and the other chamber being connected to the brakes, the piston comprising a passage in the piston and a valve, opening of the valve being controlled by a position of the piston, the position of the piston being controlled by pressure difference between the two chambers, closing of the valve causing the pressure limitation in the brakes, the position of the piston being controlled by the actuator.

29: A braking system for an automobile according to claim 27, in which the actuator is a solenoid powered by the generated current or an image of the generated current, and a mobile element in the solenoid, the position of the mobile element defining the cut off pressure, or the actuator is of piezoelectric type, or the actuator is of electric motor type coupled to a helical transmission.

30: A braking system for an automobile according to claim 28, in which the actuator is a solenoid powered by the generated current or an image of the generated current, and a mobile element in the solenoid, the position of the mobile element defining the cut off pressure, or the actuator is of piezoelectric type, or the actuator is of electric motor type coupled to a helical transmission.

31: A braking system for an automobile according to claim 18, in which the pressure limitation electrical actuator is connected directly to terminals of an electric machine.

32: A braking system for an automobile according to claim 18, comprising a toroidal current transformer at an output from the electric machine,

33: A braking system for an automobile according to claim 18, comprising a Hall effect sensor to which the electrical actuator is connected.

34: A braking system for an automobile according to claim 18, in which the electric braking subsystem comprises at least one electric braking device at a wheel to actuate the brakes and in which the electrical actuator applies a force opposing the force applied by the electric braking device.

35: A braking system for an automobile according to claim 18, in which the electric braking subsystem comprises at least one electric braking device at a wheel to actuate the brakes and in which the electrical actuator comprises a coil in which the generated current or an image of the generated current circulates, creating a magnetic field opposing the field created by the braking device.

36: The braking system for an automobile according to claim 18, in which the electric braking subsystem comprises at least one electric braking device at each wheel to actuate the brakes and in which the electrical actuator comprises an electric circuit capable of subtracting the generated current or the image of the generated current from the control current of the electric braking device.

37: The braking system for an automobile according to claim 18, comprising a switch in a power supply circuit of the electrical actuator, the switch being open when the driver does not give an order to brake and is closed when the driver gives the order to brake.
